(19) United States
(12) Patent Application Publication
(10) Pub. No.: US 2002/0032748 A1
(43) Pub. Date: Mar. 14, 2002

(54) Communication apparatus detecting method

(76) Inventor: Toshihiko Myojo, Kanagawa (JP)

Correspondence Address: MORGAN & FINNEGAN, L.L.P., 345 PARK AVENUE, NEW YORK, NY, 10154, US

(21) Appl. No.: 09/950,873

(22) Filed: Sep. 12, 2001

(30) Foreign Application Priority Data
Sep. 12, 2000 (JP) 2000-276955

(51) Int. Cl. G06F 15/16

(52) U.S. Cl. 709/217; 709/229

(57) ABSTRACT

When a communication program starts, it operates to transmit inquiry signals to detect available terminals. After the inquiry signals are transmitted, a selection state of a program is detected. If the communication program is selected, inquiry signals are again transmitted. If detected terminals are displayed as a result of the transmission of inquiry signals and one of them is selected, inquiry signals are transmitted, the selected terminal is detected, and data is input from the detected terminal. If a print is selected, inquiry signals are transmitted, and if a printer selection process is selected after the inquiry signals are transmitted, inquiry signals are transmitted.

### BACKGROUND OF THE INVENTION

1. Field of the Invention

The present invention relates to a communication apparatus detecting method.

2. Related Background Art

Data communication among a plurality of terminals includes communication using wired networks stipulated in specification such as Ethernet and wireless communication stipulated in specifications such as IrDA (infrared data association) and Bluetooth.

In data communication among a plurality of terminals having such communication function, a terminal detection operation is performed to detect terminals capable of data communication.

For example, a wireless communication terminal which performs mobile data communication by using radio waves executes a terminal detection operation to detect any terminal in the communication area, prior to actual data communication.

With this terminal detection operation, a fixed control channel assigned a predetermined frequency is used to transmit an inquiry signal to this channel and receive a response signal to the transmitted inquiry signal to thereby detect a terminal.

A frequency hopping communication system is known in which communication is performed by switching the transmission/reception frequency channel in the unit of a data block used for data communication, typically in the unit of a packet, in accordance with a predetermined switching pattern.

In the frequency hopping communication system, an inquiry signal is transmitted by using a predetermined terminal detection hopping pattern and a response signal to the transmitted inquiry signal is received to detect a terminal.

By using these detection methods, a terminal which requests for data communication detects a terminal in a communication area to perform data communication.

In a communication control program which executes a terminal detection operation when the program starts, a terminal user is required to initiate the terminal detection operation in order to obtain latest information of a terminal in the communication area.

There is another communication control program which automatically executes a terminal detection operation each time a predetermined time elapses after the program starts, to obtain latest information of a terminal in the communication area.

However, a user is required to perform a plurality of operations in order to obtain latest information of a terminal in the communication area by starting the communication program and initiating the terminal detection operation.

For example, the user selects a communication program displayed on the screen, thereafter operates to display a menu, and then selects an item for the selection of a terminal detection operation to perform the terminal detection operation.

In order to automatically obtain latest information of a terminal in the communication area each time a predetermined time elapses, the terminal detection operation is performed each time a predetermined time elapses even if it is unnecessary to obtain the latest information, i.e., even if the communication is not performed.

The terminal detection operation uses some transmission band of data communication so that the transmission band becomes insufficient and other data communication may become difficult.

### SUMMARY OF THE INVENTION

The invention has been made to overcome the above-described problems.

It is an object of the invention to efficiently utilize the transmission band and easily obtain latest information of a terminal capable of data communication.

It is another object of the invention to display information of detected terminals capable of data communication and establish a connection by selecting a displayed terminal to thereby perform data communication.

It is still another object of the invention to easily establish a connection when a preset terminal is detected to thereby perform data communication.

It is still another object of the invention to reliably confirm a terminal capable of data communication when data is to be input/output or printed, or when an image is to be displayed.

### BRIEF DESCRIPTION OF THE DRAWINGS

FIG. 1 is a diagram showing the structure of a data communication system according to a first embodiment.

FIG. 2 is a block diagram showing the structure of a server 101.

FIG. 3 is a timing chart illustrating a terminal detection operation and a connection establishment operation to be executed by the server 101.

FIG. 4 is a diagram showing an example of a display screen of the server 101.

FIG. 5 is a flowchart illustrating the operation of the server 101.

FIG. 6 is a diagram showing another example of the structure of a data communication system embodying the invention.

FIG. 7 is a diagram showing an example of a display screen of a server 601.

FIG. 8 is a diagram showing the structure of a data communication system according to a second embodiment.

FIG. 9 is a block diagram showing the structure of a server 801.

FIG. 10 is a diagram showing an example of a display screen of the server 801.

FIG. 11 is a flowchart illustrating a print selection process to be executed by the server 801.

FIG. 12 is a flowchart illustrating a printer search process to be executed by the server 801.

FIG. 13 is a diagram showing the structure of a data communication system according to a third embodiment.

FIG. 14 is a block diagram showing the structure of a server 1301.

FIG. 15 is a flowchart illustrating a thumbnail read operation to be executed by the server 1301.

### DETAILED DESCRIPTION OF THE PREFERRED EMBODIMENTS

(First Embodiment)

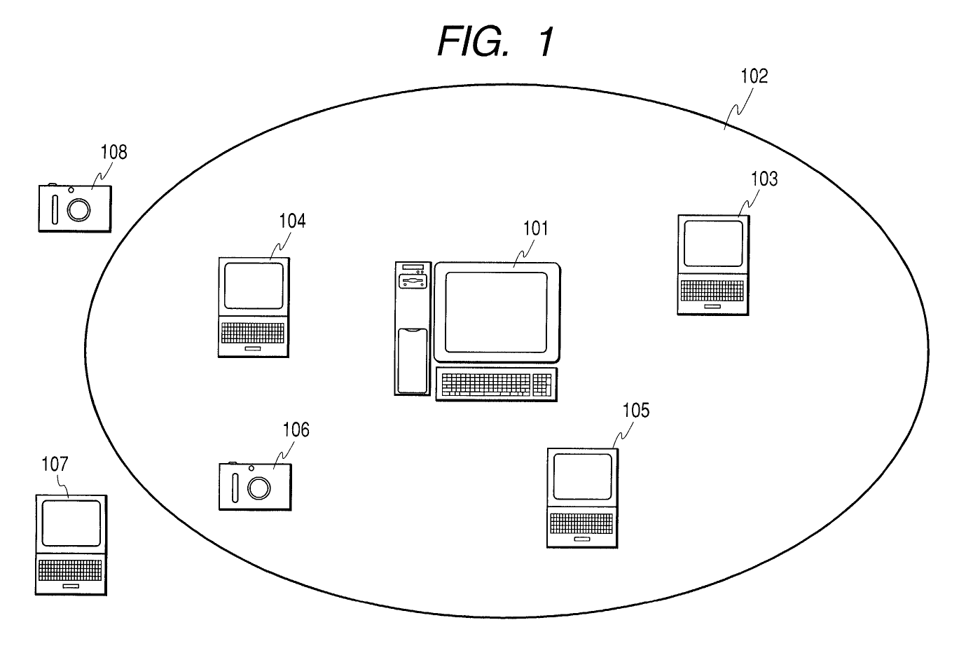

FIG. 1 is a diagram showing the structure of a data communication system according to the first embodiment of the invention.

In FIG. 1, reference numeral 101 represents a server (computer) which has a function of collectively controlling communication of the data communication system.

Reference numerals 103, 104, 105 and 107 represent terminals such as lap-top computers having a wireless communication function. Reference numerals 106 and 108 represent image processing terminals such as digital cameras having a wireless communication function.

Reference numeral 102 represents a communication area of the server 101. The server 101 can perform wireless communication in the communication area 102 including the server 101, and cannot perform wireless communication outside the communication area 102.

Namely, in the example shown in FIG. 1, the server 101 can perform wireless communication with the terminals 103, 104 and 105 and the image processing terminal 106.

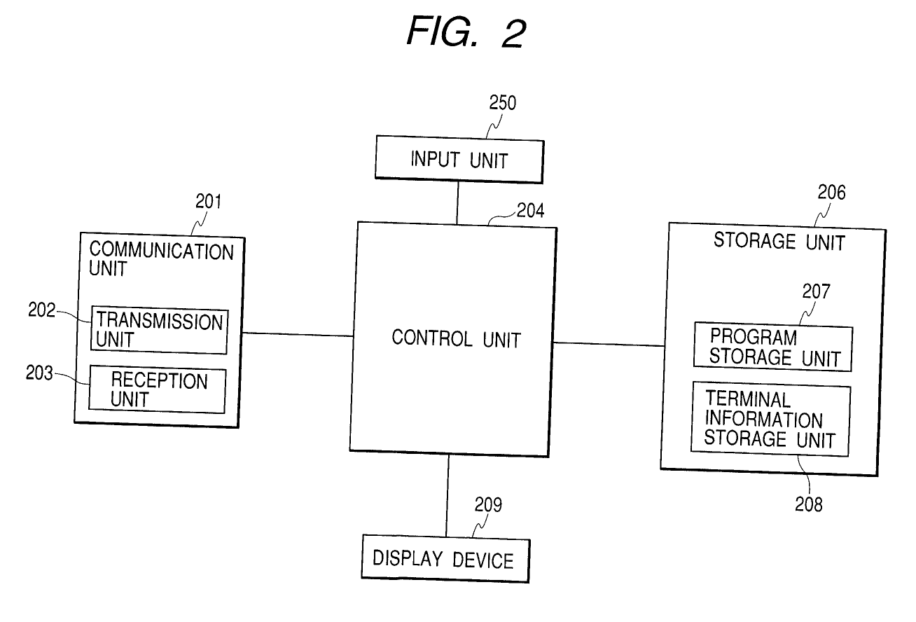

FIG. 2 is a block diagram showing the structure of the server 101 shown in FIG. 1.

In FIG. 2, reference numeral 201 represents a communication unit which is constituted of a transmission unit 202 and a reception unit 203.

The transmission unit 202 transmits an inquiry signal for the detection of a terminal, transmission data and the like via a wireless channel in accordance with an instruction from a control unit 204. When the reception unit 203 receives an inquiry signal transmitted from another terminal at a standby frequency, a response signal is transmitted from the transmission unit 202. The reception unit 203 receives a response signal to a transmitted inquiry signal and reception data via a wireless channel.

The control unit 204 reads a program stored in a program storage unit 207 of a storage unit 206 to control each functional unit in accordance with the read program. The control unit 204 has an operation detection function of detecting whether or not an input unit 250 selects a communication program.

The storage unit 206 is constituted of the program storage unit 207 and a terminal information storage unit 208. The program storage unit 207 stores programs such as the communication program and a text edition program. The terminal information storage unit 208 stores information of a detected terminal in accordance with a response signal received at the reception unit 203 as a response to the inquiry signal transmitted from the transmission unit 202.

Reference numeral 209 represents a display unit.

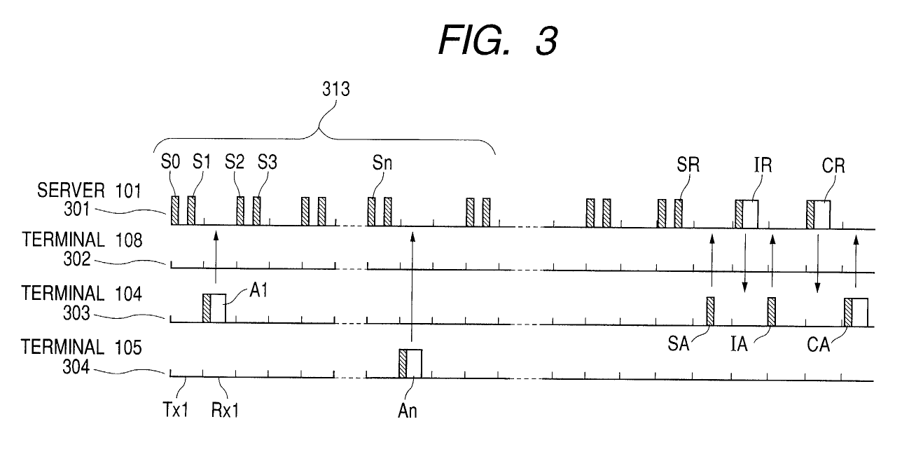

FIG. 3 is a timing chart illustrating a terminal detection operation and a connection establishment operation to be executed by the server 101 shown in FIG. 1.

In FIG. 3, reference numeral 301 represents a transmission/reception timing signal of the server 101 shown in FIG. 1, and reference numeral 302 represents a transmission/reception signal of the image processing terminal 108 outside the communication area of the server 101. Reference numerals 303 and 304 represent transmission/reception signals of the terminals 104 and 105 in the communication area of the server 101.

With reference to FIG. 3, the terminal detection operation of the server 101 will be described.

First, when the communication program of the server 101 is activated, the control unit 204 of the server 101 starts transmitting inquiry signals for the detection of a terminal.

Upon reception of a transmission instruction for inquiry signals, the transmission unit 202 repetitively transmits inquiry signals by using a frequency band which is a half of the frequency band of a control channel and by shifting the frequency band.

Specifically, the server 101 selects a predetermined frequency fk from a predetermined hopping sequence value for the terminal detection, in accordance with the status of a system clock of the server 101. Inquiry signals are transmitted by gradually changing the frequency from the frequency fk to frequencies fk+1, fk+2, . . . , fk+31.

The frequency band which is the half of the frequency band of the control channel corresponds to the band from the frequency fk to the frequency fk+31.

Two inquiry signals are transmitted by using one transmission slot. For example, in a first transmission slot (Tx1), two inquiry signals S0 and S1 are transmitted having different frequencies fk and fk+1, respectively.

In a reception slot following the transmission slot, the server 101 performs a reception operation at the two frequencies used for transmitting the inquiry signals in order to receive a response signal to the inquiry signals. For example, in a first reception slot (Rx1) following the first transmission slot (Tx1), the server performs the reception operation at the frequencies fk and fk+1 of the inquiry signals S0 and S1.

A terminal (e.g., terminal 104 shown in FIG. 1) for receiving the inquiry signals S0 and S1 enters an inquiry signal reception standby state when it is not performing data communication with another terminal. In this inquiry signal reception standby state, the terminal performs the reception operation at one (hereinafter called a “standby frequency”) of the two frequencies used for the inquiry signals, during a period of predetermined transmission/reception slots (e.g., 18 slots).

During this reception operation, specific 32 terminal detection hop frequencies are used in accordance with a terminal detection hopping pattern. The phase of a reception timing is determined by the system of a terminal which performs the detection operation, and changes, for example, every 1.28 sec.

When the inquiry signal transmitted from the server 101 at the standby frequency is received during the reception operation, a response signal at the standby frequency is transmitted as a response to the received inquiry signal. For example, if the terminal 104 is in the reception standby state at the standby frequency fk and receives the inquiry signal S0 (frequency fk) transmitted in the first transmission slot Tx1, the operation state changes to a detection response state. Then, a response signal A1 at the frequency fk is transmitted in the first reception slot rx1. This response signal A1 contains an address, type and the like of the terminal 104.

Upon reception of the response signal A1 in the first reception slot rx1, the server 101 registers information of the address, type and the like contained in the response signal A1 in the terminal information storage unit 208 as the terminal in the communication area, and continues the terminal detection operation by changing the frequency of the inquiry signal. Namely, in a second transmission slot Tx2, the server transmits inquiry signals S2 (frequency fk+2) and S3 (frequency fk+3).

Similarly, when a terminal 105 in the reception standby state at a standby frequency fk+n receives an inquiry signal Sn (frequency fk+n) from the server 101, the terminal 105 transmits a response signal An in the next reception slot.

Upon reception of the response signal An, the server 101 registers information of the address, type and the like of the terminal 105 in the terminal information storage unit 208.

If the inquiry signal transmitted from the server 101 during the reception operation is not received, the terminal changes the standby frequency after the lapse of the predetermined period in accordance with the frequency hopping pattern determined for the inquiry signal reception, and again continues the reception operation.

The inquiry signal is transmitted by repeating to scan the selected half of frequencies a plurality of times (e.g., 256 times) and thereafter by repeating to scan the remaining frequencies a plurality of times. This scanning is repeated during a predetermined time or in a range of 313 times, and after the lapse of the predetermined time or the completion of the range of 313 times, the terminal detection operation is terminated.

Next, with reference to FIG. 3, the connection establishment operation will be described.

First, as a user of the server 101 performs a connection request operation for the terminal (e.g., terminal 104) which was detected by the terminal detection operation, the server 101 transmits an access code representative of the address of the terminal to the terminal as a connection request signal SR. This connection request signal SR is transmitted at the frequency assumed from the hopping pattern generated based upon the information obtained by the terminal detection operation.

However, since the server 101 does not know the timing when the partner terminal receives the connection request, the server 101 transmits the same connection request signal SR at a different hop frequency until the response from the terminal is received. Similar to the terminal detection operation, in the reception slot following the transmission of the connection request signal, the server 101 stands by to receive the response by using the same frequency as that used by transmitting the request.

Assuming that a frequency f1 is selected from the hop sequence presumed by the server 101, the connection request signal is transmitted by changing the request frequency from the frequency f1 to f1+l, f1+2 and so on (The frequency selection method is not limited only thereto, but the frequency may be selected in the order of f1-8, f1-7, . . . , f1+7. This is also applied to the frequency selection operation for the terminal detection operation).

The terminal 104 having the address indicated by the connection request signal SR executes the standby operation for receiving the connection request signal, at the frequency selected by the hopping pattern generated from the address, by using a portion of the period while the standby operation for receiving the terminal detection signal is not performed, in order to receive the connection request signal from another terminal.

Referring to FIG. 3, when the terminal 104 receives the connection request signal SR from the server 101 while the terminal 104 performs the connection request standby operation at the frequency f1+3, the terminal 104 enters a connection response state to send back a request response signal SA by using the same frequency f1+3 as that for the received connection request signal SR.

Upon reception of this request response signal SA, the server 101 transmits the information IR necessary for setting a communication channel to the terminal 104.

Upon reception of this information IR, the terminal 104 transmits a response signal IA by using the same frequency as that used for receiving the information IR, stores the timing and hopping pattern of a communication channel in accordance with the received information IR, and changes the frequency to the next frequency in accordance with the determined hopping pattern of the communication channel to thereafter stand by to receive a confirmation signal CR for the connection establishment.

Upon reception of the response signal IA, the server 101 transmits the confirmation signal CR. Upon reception of this confirmation signal CR, the terminal sends back a confirmation response CA. The connection establishment is completed by the transfer of these confirmation signal CR and confirmation response signal CR.

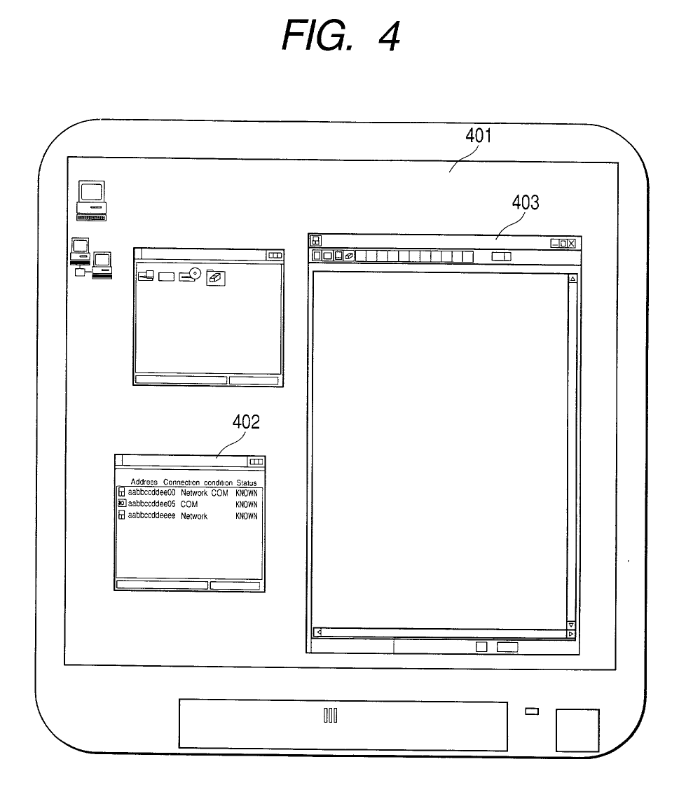

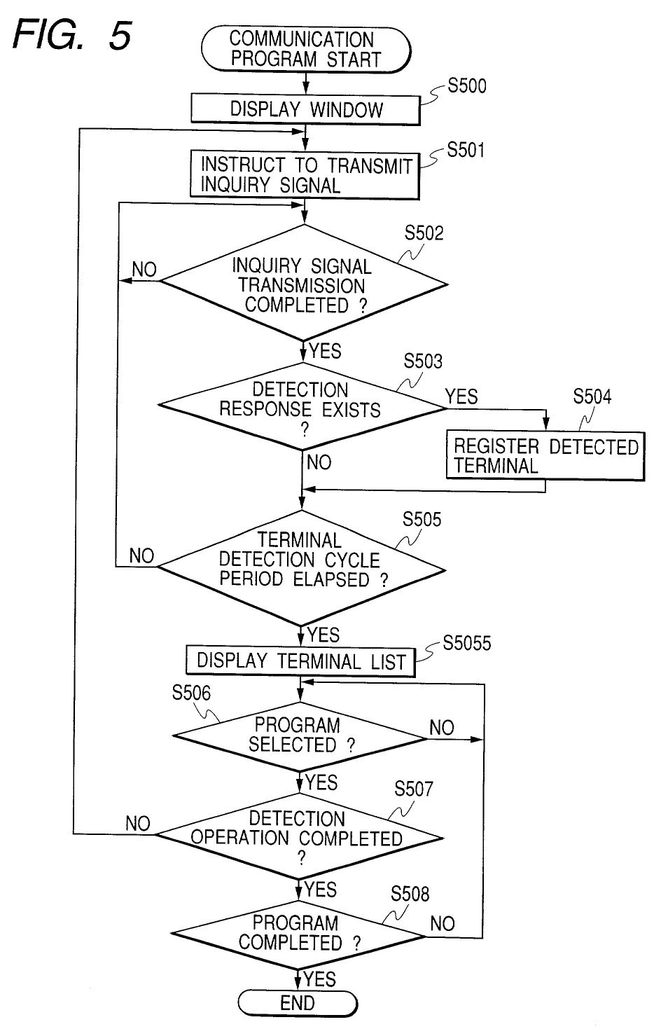

Next, the operation will be described with reference to FIGS. 4 and 5.

FIG. 4 is a diagram showing an example of a display screen of the display unit 209 of the server 101, and FIG. 5 is a flowchart illustrating the operation of the server 101.

Referring to FIG. 4, reference numeral 401 represents a display screen of the display unit 209, reference numeral 402 represents a window of the communication program, and reference numeral 403 represents a window of the text edition program or the like.

FIG. 5 illustrates a portion of a program stored in the program storage unit 207. The control unit 204 is a computer which operates by reading the program from the program storage unit 207. The program storage unit 207 is a storage medium storing the program which the control unit 204 can read. This program may be stored in an external storage medium such as a floppy disk and a CD-ROM and the control unit 204 reads the program via an unrepresented floppy disk drive or CDROM drive. In this case, the program storage unit 207 corresponds to the storage medium storing the program which the control unit 204 can read. The program may be supplied externally to the control unit 204 via the reception unit 203. The operation of the server 101 to be executed under the control of the control unit 204 will be described.

Referring to FIG. 5, as the communication program is selected by selecting an unrepresented menu selection button or the like on the display screen 401 of the server 101 or by clicking a start-up button for the communication program, the communication program starts. The control unit 204 of the sever 101 displays the window 402 of the communication program on the display screen 401 (S500) to instruct a transmission of inquiry signals for the terminal detection (S501). Upon reception of this transmission instruction for inquiry signals, the transmission unit 202 transmits inquiry signals at the frequencies fk to fk+31 as shown in FIG. 3. Another example of selecting the communication program is to double-click an icon of the communication program displayed on the display unit 209 with a mouse of the input unit 250.

After the transmission of the inquiry signals at the frequencies fk to fk+31 is completed (S502), the control unit 204 of the server 101 judges whether there is a response from a terminal to the transmitted inquiry signal (S503). Namely, the control unit 204 judges whether a response signal is received at the same frequency as that of the transmitted inquiry signal. If it is judged that there is a response from the terminal to the transmitted inquiry signal, then at Step S504 the address and the like of the terminal which transmitted the response to the inquiry signal is registered in the terminal information storage unit 208. The flow thereafter advances to Step S505. On the other hand, if there is no response from the terminal to the transmitted inquiry signal, no process is executed to advance to Step S505.

At Step S505, the server 101 judges whether the inquiry signals were transmitted during a predetermined period or a predetermined number of times. If it is judged that the inquiry signals are still not transmitted during the predetermined period or the predetermined number of times, the flow returns to Step S502 to execute Steps S502 to S505.

If it is judged that the inquiry signals were transmitted during the predetermined period or the predetermined number of times, at Step S5055 a list of terminals in the communication area detected during the terminal detection operation is displayed in the window 402 of the communication program. Thereafter, the flow advances to Step S506 whereat a selection state of the communication program is detected. The list of terminals may be displayed at Step S504 instead of Step S5055.

In the list of detected terminals displayed in the window 402 of the communication program, “KNOWN” in the “Status” column indicates that the terminal was detected in the previous terminal detection operation and also in the latest terminal detection operation. The terminal displayed with “Response present” in the “Status” column is a terminal which was detected in the latest terminal detection operation although it was not detected in the previous terminal detection operation.

At Step S506 the control unit 204 of the server 101 judges whether the communication program is being selected by a selection operation from the input unit 350 by the user. If it is judged that the communication program is being selected, then the flow advances to Step S507, whereas if not, the flow stands by until the program is selected.

At Step S507, the server 101 judges whether the terminal detection operation from Step S501 to Step S505 is completed. If not completed, the flow returns to Step S501 to perform the terminal detection operation.

If the terminal detection operation is completed and the communication program is completed, the process is terminated, whereas if not, the flow returns to Step S506 to stand by until the communication program is selected (S508).

Namely, if the communication program is being selected even after the communication program starts and the terminal detection operation from Step S501 to S505 is completed, the flow returns to Step S506 via YES at Step S506, YES at Step S507 and NO at Step S508.

If a program (e.g., text edition program) other than the communication program is selected thereafter, a NO routine at Step S506 is repeated until the communication program is selected. The display unit 209 displays the title of the selected program and the title of programs not selected in different colors.

Thereafter, when the communication program is selected from the input unit 250, the terminal detection operation from Step S501 to Step S505 is performed via YES at Step S506 and NO at Step S507.

As above, at Steps S506 to S508, if the program other than the communication program such as the text edition program is executed after the communication program starts, i.e., as shown in FIG. 4, if a plurality of windows including the window 403 is displayed and the program other than the communication program is selected, and when the input unit 250 selects the window 402 of the communication program, the server 101 performs the terminal detection operation.

As shown in FIG. 4, if a plurality of programs start and windows thereof are displayed on the display unit 209, for example, one of a plurality of programs (i.e., one of a plurality of windows) can be selected by using the mouse of the input unit 250.

After the communication program starts and performs the terminal detection operation from Step S501 to Step S505, the judgement at Step S507 is YES so that the flow does not return to Step S501 but stands by at a first routine including YES at Step S506, YES at Step S507 and NO at Step S508. If a program other than the communication program is selected, the communication program stands by at he second routine including NO at Step S506. The first routine corresponds to the state that the communication program is being selected, and the second routine corresponds to the state that a program other than the communication program is being selected.

During this second routine, if the communication program is selected by the selection operation of the input unit 250, then the second routine is dismissed to advance to Step S501 via YES at Step S506 and NO at Step S507 to perform the terminal detection operation.

The terminal detection operation is performed each time the window 402 of the communication program is selected by the input unit 250. After the communication program is selected and the terminal detection operation is completed, the terminal detection operation is not performed via the route from YES at Step S507 to Step S508.

As detailed in the above description, according to the embodiment, after the communication program starts, if a program other than the communication program is executed and the communication program is selected by the user by using the input unit, then the control unit 204 detects that the communication program was selected. In accordance with this detection result and an instruction from the control unit 204, the transmission unit 202 transmits inquiry signals for detecting a terminal.

Therefore, only when the communication program is selected, i.e., only when data communication is requested, inquiry signals are transmitted to detect a terminal. Accordingly, the transmission band of data communication can be utilized efficiently, and it is possible to detect a terminal and obtain latest information of the terminal simply by the user operation of selecting the communication program.

The information of the terminal detected by the terminal detection operation is stored in the terminal information storage unit 208 and the list of terminals is displayed on the window 402 of the communication program. It is therefore possible to set easily the terminal for data communication.

In this embodiment, a data communication system for wireless data communication is used. The invention is not limited only thereto, but is applicable to the data communication systems for both wireless data communication and wired data communication, or for wired data communication.

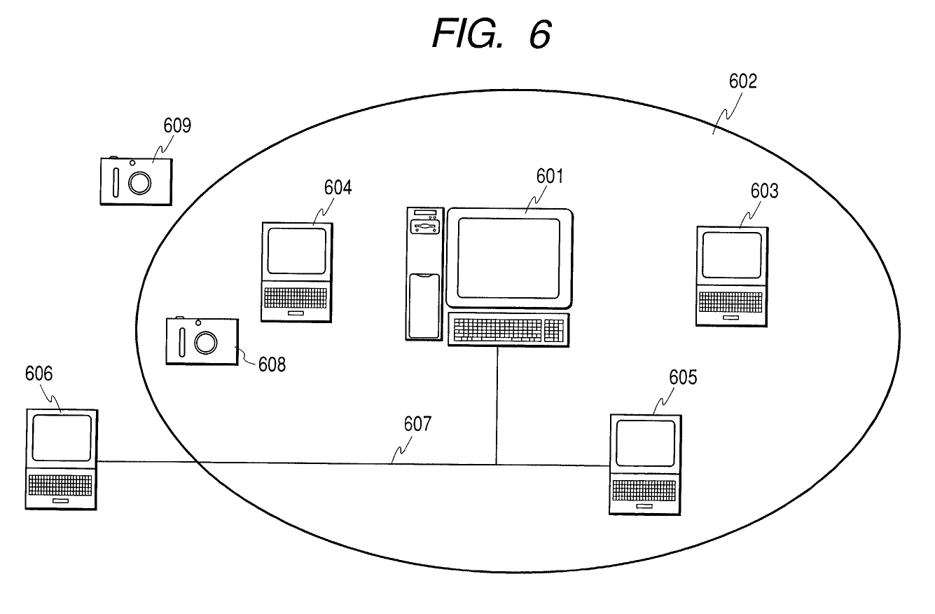

For example, as shown in FIG. 6, the invention is applicable to a data communication system for both wireless communication and wired communication.

FIG. 6 is a diagram showing another example of the structure of a data communication system embodying the invention.

In FIG. 6, reference numeral 601 represents a server (computer) which provides the communication unit 201 of the server 101 shown in FIG. 2 with an additional function of communicating with terminals 605 and 606 via a LAN (Local Area Network) 607.

Reference numerals 603 and 604 represent terminals such as lap-top computers having a wireless communication function. Reference numerals 605 and 606 represent terminals such as lap-top computers connected to LAN 607. Reference numerals 608 and 609 represent image processing terminals such as digital cameras having a wireless communication function.

Reference numeral 602 represents a wireless communication area of the server 601. The server 601 can perform wireless communication in the communication area 602 including the server 601, and cannot perform wireless communication outside the communication area 602. The terminals 605 and 606 can communicate with the server 601 irrespective of whether they are in or outside the wireless communication area.

When the invention is applied to the data communication system shown in FIG. 6, in the terminal detection operation shown in FIG. 5, Steps (S501 to S505) for detecting and registering a terminal are executed to detect also the terminals connected to LAN 607.

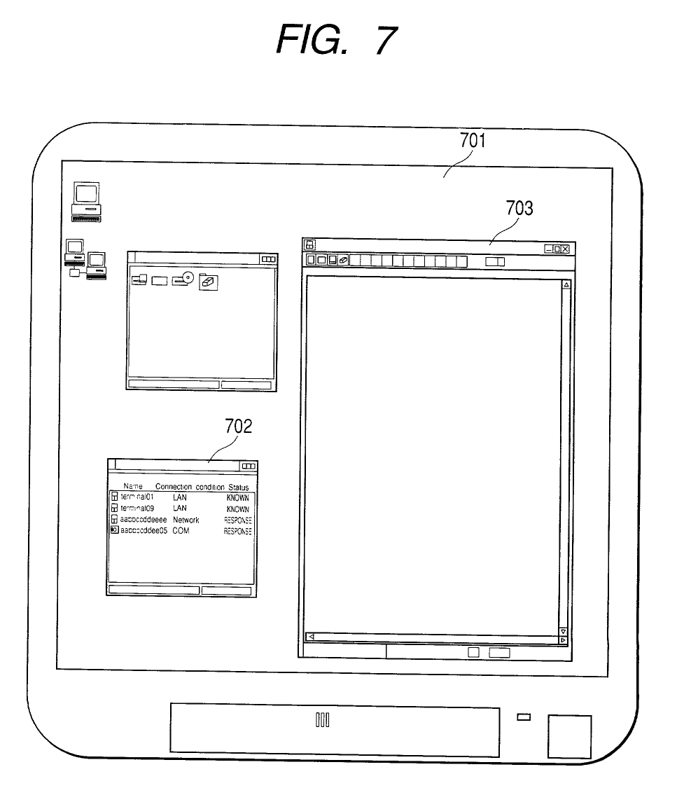

FIG. 7 shows an example of a display screen of the server 601 of the data communication system shown in FIG. 6.

In FIG. 7, reference numeral 701 represents a display screen of a display unit, reference numeral 702 represents a window of a communication program, and reference numeral 703 represents a window of a text edition program or the like. In the window 702 of the communication program, detected terminals with the wireless communication function as well as terminals connected to LAN 607 are displayed.

(Second Embodiment)

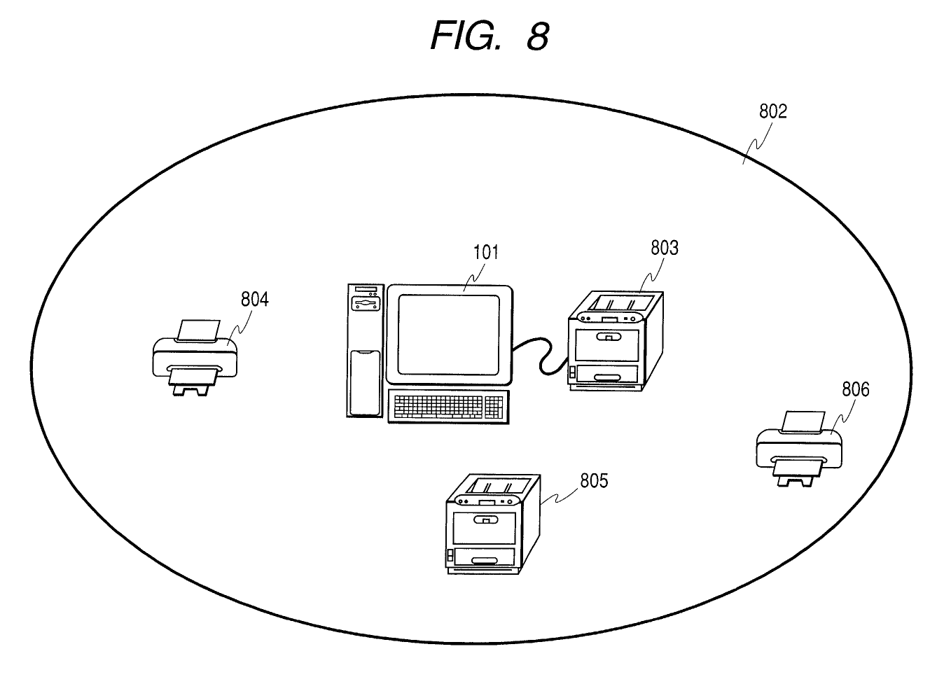

FIG. 8 is a diagram showing the structure of a data communication system according to the second embodiment of the invention.

In FIG. 8, reference numeral 801 represents a server (computer) which has a function of collectively controlling communication of the data communication system. In this embodiment, the server 801 transmits also print data. Reference numeral 803 represents a printer connected via a cable to the server 801 by using an interface such as Centronics. Reference numerals 804, 805 and 806 represent printers having a wireless communication function.

Reference numeral 802 represents a communication area of the server 801. The server 801 can perform wireless communication in the communication area 802 including the server 801, and cannot perform wireless communication outside of the communication area 802. In the example shown in FIG. 8, all the printers 804 to 806 having the wireless communication function are in the communication area of the server 801 so that they can have wireless communication with the server 801.

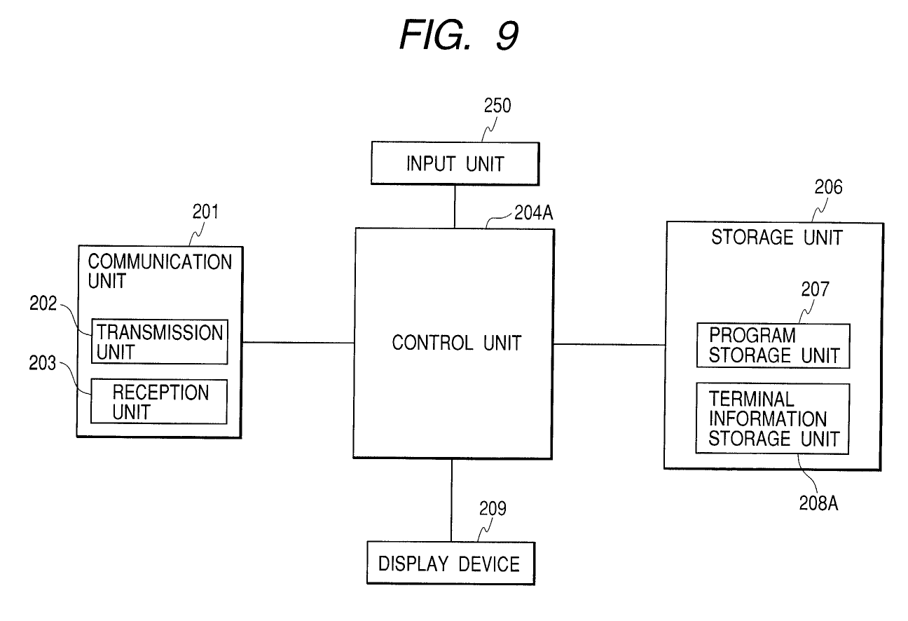

FIG. 9 is a block diagram showing the structure of the server 801 shown in FIG. 8.

In FIG. 9, the same functional blocks as those shown in FIG. 2 are represented by identical reference numerals and the duplicated description thereof is not given.

In FIG. 9, reference symbol 204A represents a control unit which is constituted of an operation detection unit and a detection unit (not shown). The control unit 204A controls each functional unit in accordance with a program read from the program storage unit 207.

The control unit 204A detects whether a preset terminal is included in terminals detected by the terminal detection operation. Namely, the control unit 204A compares the information of the preset terminal stored in a terminal information storage unit 208A with the information of terminals detected by the terminal detection operation. If this comparison result shows a coincidence between the information of the preset terminal and information of terminals detected by the terminal detection operation, it is judged that the preset terminal was detected.

The terminal information storage unit 208A stores the information of each detected terminal and the information of the preset terminal.

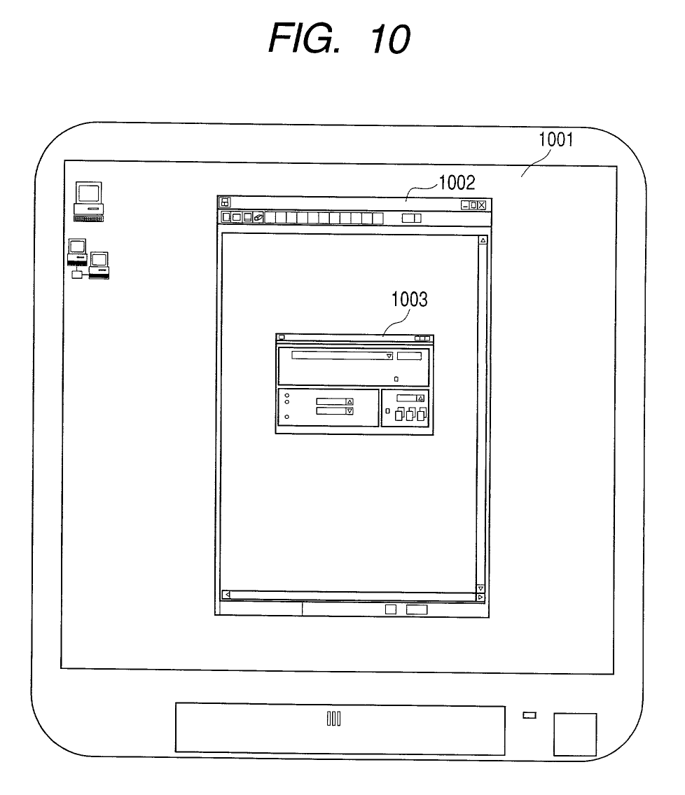

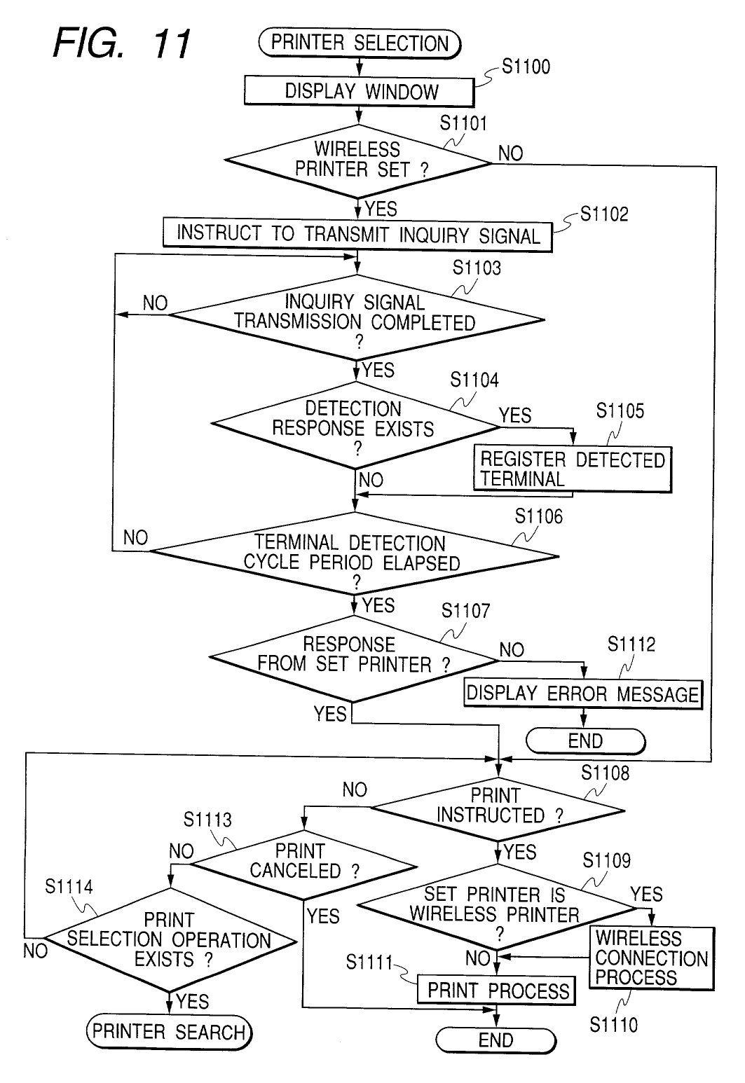

Next, the operation will be described with reference to FIGS. 10 and 11.

FIG. 10 is a diagram showing an example of a display screen of the display unit 209 of the server 801, and FIG. 11 is a flowchart illustrating the operation of the server 801.

The flowchart shown in FIG. 11 illustrates a portion of a program stored in the program storage unit 207. The control unit 204A is a computer which operates to execute the processes illustrated in FIG. 11 by reading the program from the program storage unit 207. The program storage unit 207 is a storage medium storing the program which the control unit 204A can read. This program may be stored in an external storage medium such as a floppy disk and a CD-ROM and the control unit 204A reads the program via an unrepresented floppy disk drive or CD-ROM drive. In this case, the program storage unit 207 corresponds to the storage medium storing the program which the control unit 204A can read. The program may be supplied externally to the control unit 204A via the reception unit 203.

In FIG. 10, reference numeral 1001 represents a display screen of a display unit 209, reference numeral 1002 represents a window of a text edition program or the like, and reference numeral 1003 represents a print instruction window of a document edited by the text edition program or the like. In the following, the operation of the server 801 to be executed under the control of the control unit 204A will be described.

Referring to FIG. 10, as a user of the server 801 requests for printing a document edited by a text edition program or the like, from the input unit 250, a print instruction window 1003 is displayed on the display screen of the server 801 at Step S1100 to start a printer selection process.

At Step S1101, the server 801 judges whether the printer (hereinafter called a “default printer” preset in the terminal information storage unit 208A) is a printer (hereinafter called a “wireless printer”) having a wireless communication function. If it is judged that the default printer is a wireless printer, the flow advances to Step S1102, whereas if not, the flow jumps to Step S1108.

If it is judged at Step S1101 that the default printer is a wireless printer, at Step S1102 the control unit 204A of the server 801 instructs the transmission unit 202 to transmit inquiry signals for the printer detection. Upon reception of this instruction, the transmission unit 202 transmits inquiry signals. Similar to the first embodiment, the inquiry signals are transmitted at the frequencies fk to fk+31.

After the transmission of the inquiry signals at the frequencies fk to fk+31 is completed (S1103), the control unit 204A of the server 801 judges whether there is a response from a wireless printer to the transmitted inquiry signal (S1104). If it is judged that there is a response from the wireless printer to the transmitted inquiry signal, then at Step S1105 the address and the like of the wireless printer which transmitted the response to the inquiry signal is registered in the terminal information storage unit 208A. The flow thereafter advances to Step S1106. On the other hand, if there is no response from a printer to the transmitted inquiry signal, the flow advances to Step S1106.

At Step S1106, the server 801 judges whether the inquiry signals were transmitted during a predetermined period or a predetermined number of times. If it is judged that the inquiry signals are still not transmitted during the predetermined period or the predetermined number of times, the flow returns to Step S1103 to execute Steps S1103 to S1106.

If it is judged that the inquiry signals were transmitted during the predetermined period or the predetermined number of times, at Step S1107 it is judged whether there is a response from the default printer during the terminal detection operation. Namely, the information of the wireless printer registered at Step S1105 of the detection operation is compared with the information of the default printer stored beforehand in the terminal information storage unit 208A to judge whether the default printer is included in wireless printers registered at Step S1105.

If it is judged that there is no response from the default printer, the flow advances to Step S1112 whereat an error message is displayed on the display screen of the server 801 to terminate the printer selection process. If there is a response from the default printer, the flow advances to Step S1108.

Step S1108 waits for an instruction from the user. As the user makes an instruction from the input unit 250, it is checked at Step S1108 whether the input instruction is a print instruction. If it is judged at Step S1108 that the input instruction is a print instruction, the flow advances to Step S1109 whereat it is checked whether the default printer is a wireless printer. If the default printer is not a wireless printer, the flow advances to Step S1111, whereas if it is a wireless printer, at Step S1110 a wireless connection process, i.e., a connection establishment operation, is performed to thereafter advance to Step S1111. This connection establishment operation corresponds to the operation from the transmission of the connection request signal SR to the reception of the confirmation response CA described with reference to the last half of FIG. 3. At Step S1111 a print process is performed to thereafter terminate the printer selection process.

In the printer selection process, if the default printer is a wireless printer and there is a response from the default printer at Step S1107, or if the default printer is not a wireless printer, the print instruction may not be awaited at Step S1108, but the flow may directly advance to Step S1109.

If the input instruction is not a print instruction at Step S1108, the flow advances to Step S1113 whereat it is checked whether the input instruction is a print cancel instruction. If the input instruction is a print cancel instruction, the printer selection process is terminated. On the other hand, if the input instruction is not a print cancel instruction, the flow advances to Step S1114 whereat it is checked whether the input instruction is a printer selection instruction.

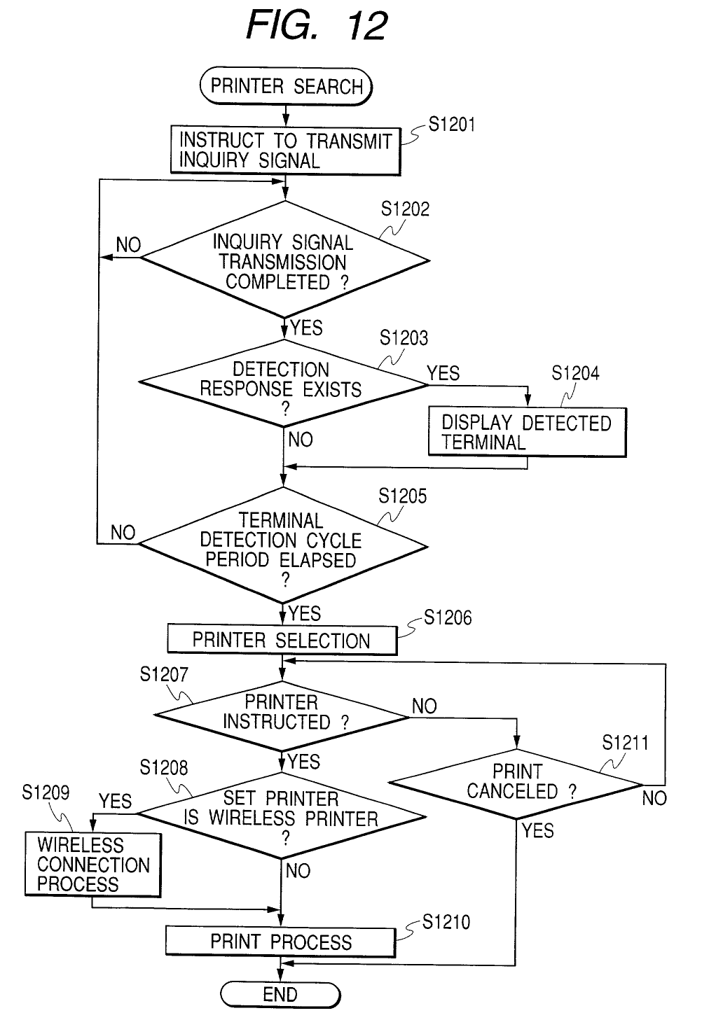

If the input instruction is a printer selection instruction, a printer search process illustrated in FIG. 12 is executed, whereas if not, the flow returns to Step S1108. An example of this printer selection instruction is an instruction to display a list of usable printers in a pull-down menu of the print instruction window 1003. More specifically, the printer selection instruction is to click a v button on the right side of a default printer name in the print instruction window 1003 with a mouse of the input unit 250.

FIG. 12 is a flowchart illustrating a printer search process which starts when the input instruction is a printer selection instruction at Step S1114.

First, similar to Step S1102 shown in FIG. 11, at Step S1201 the control unit 204A of the server 801 instructs the transmission unit 202 to transmit inquiry signals for the printer selection. Upon reception of this instruction, the transmission unit 202 transmits inquiry signals.

After the transmission of the inquiry signals at the frequencies fk to fk+31 is completed (S1202), the control unit 204A of the server 801 judges whether there is a response from a wireless printer to the transmitted inquiry signal (S1203). If it is judged that there is a response from the wireless printer to the transmitted inquiry signal, then at Step S1204 the address and the like of the wireless printer which transmitted the response to the inquiry signal is displayed in the print instruction window 1003 and registered in the terminal information storage unit 208A. The flow thereafter advances to Step S1205.

At Step S1205, the server 801 judges whether the inquiry signals were transmitted during a predetermined period or a predetermined number of times. If it is judged that the inquiry signals are still not transmitted during the predetermined period or the predetermined number of times, the flow returns to Step S1202 to execute Steps S1202 to S1205. If it is judged that the inquiry signals were transmitted during the predetermined period or the predetermined number of times, the flow advances to Step S1206. Instead of transmitting inquiry signals at Step S1201, terminals registered at Step S1105 may be displayed at Step S1204.

At Step S1205 one of the wireless printers is selected which printers were detected by the printer detection operation and displayed in the print instruction window 1003 of the display screen 1001 of the server 801. The wired printer 803 is also displayed. After the user selects a printer by using the input unit at Step S1206, the flow advances to Step S1207.

Step S1207 waits for an instruction from the user. As the user makes an instruction from the input unit 250, the process from Step S1207 starts to judge whether the input instruction is a print instruction. If it is judged at Step S1207 that the input instruction is a print instruction, the flow advances to Step S1208 whereat it is checked whether the default printer is a wireless printer. If the default printer is not a wireless printer, the flow advances to Step S1210, whereas if it is a wireless printer, at Step S1209 a wireless connection process, i.e., a connection establishment operation, is performed to thereafter advance to Step S1210. At Step S1210 a print process is performed to thereafter terminate the printer search process.

If the input instruction is not a print instruction at Step S1207, the flow advances to Step S1211 whereat it is judged whether the input instruction is a print cancel instruction. If the input instruction is a print cancel instruction, the process is terminated, whereas if not, the flow returns to Step S1207 to await an instruction from the user.

As described above, according to the second embodiment, as a print request or the like is issued by using a text edition program or the like, the communication program for print including the text edition program or the like starts. Then, in accordance with an instruction from the control unit 204A, the transmission unit 202 transmits inquiry signals for detecting a printer. Since the inquiry signals are transmitted and printers are detected only when print data transfer is requested by a print request or the like from a user, it is possible to efficiently utilize the transmission band of data communication, and an available printer can be detected simply by issuing the print request from the user without any other operation.

The information of the default printer preset and stored in the terminal information storage unit 208A is compared with the information of the detected printer to detect whether the default printer is in the communication area. Therefore, a user can know easily whether the preset printer is in the communication area, simply by setting beforehand the information of the default printer on the user side.

Further, as a user selects a printer selection process, a printer in the communication area is automatically detected, and the detected printer is displayed to be selected. It is therefore possible for the user to use a desired printer in the communication area.

(Third Embodiment)

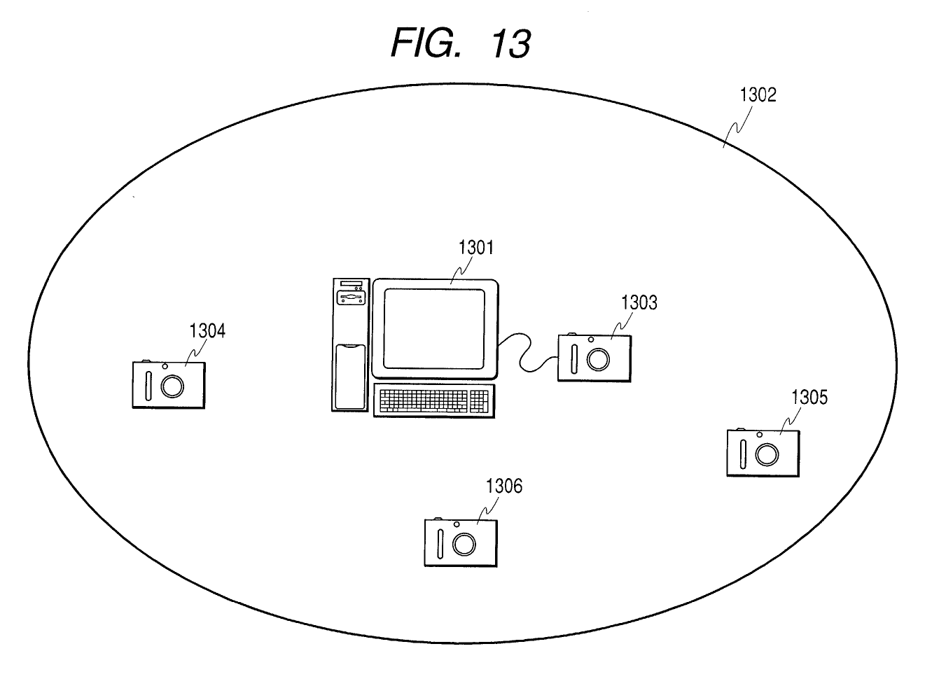

FIG. 13 is a diagram showing the structure of a data communication system according to the third embodiment of the invention.

In FIG. 13, reference numeral 1301 represents a server (computer) which has a function of collectively controlling communication of the data communication system. Reference numeral 1303 represents an image processing terminal such as a digital camera connected via a cable to the server 1301. Reference numerals 1304, 1305 and 1306 represent image processing terminals such as digital cameras having a wireless communication function.

In this embodiment, the server 1301 transfers data to and from the image processing terminals 1303 to 1306.

Reference numeral 1302 represents a communication area of the server 1301. The server 1301 can perform wireless communication in the communication area 1302 including the server 1301, and cannot perform wireless communication outside the communication area 1302.

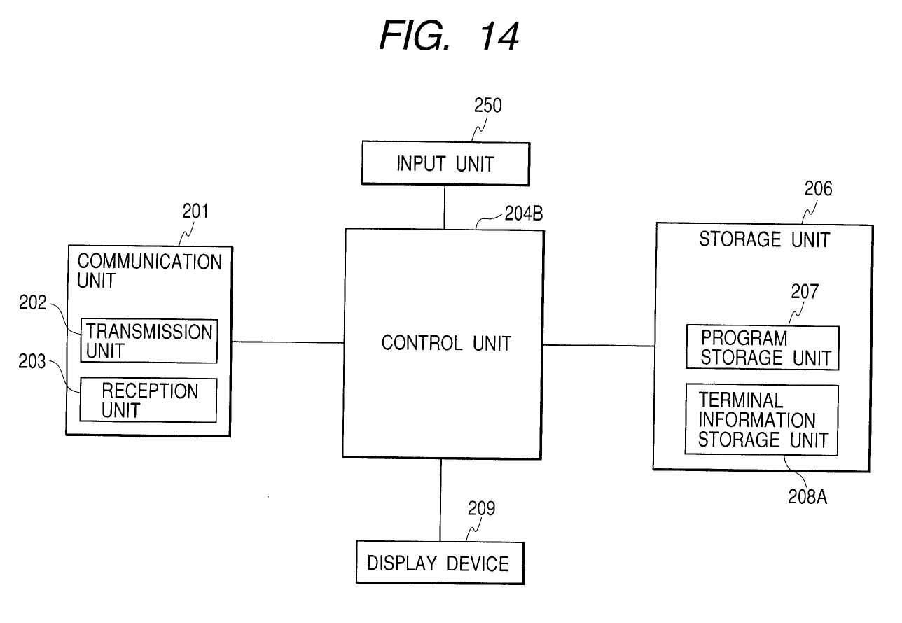

FIG. 14 is a block diagram showing the structure of the server 1301 shown in FIG. 13. In FIG. 14, the same functional blocks as those shown in FIGS. 2 and 9 are represented by identical reference numerals and the duplicated description thereof is not given.

In FIG. 14, reference symbol 204B represents a control unit which controls each functional unit in accordance with a program read from the program storage unit 207. The control unit 204B detects a terminal for data communication in accordance with an instruction input from the input unit 250. When a terminal for data communication is selected, the control unit 204B instructs the transmission unit 202 to transmit inquiry signals.

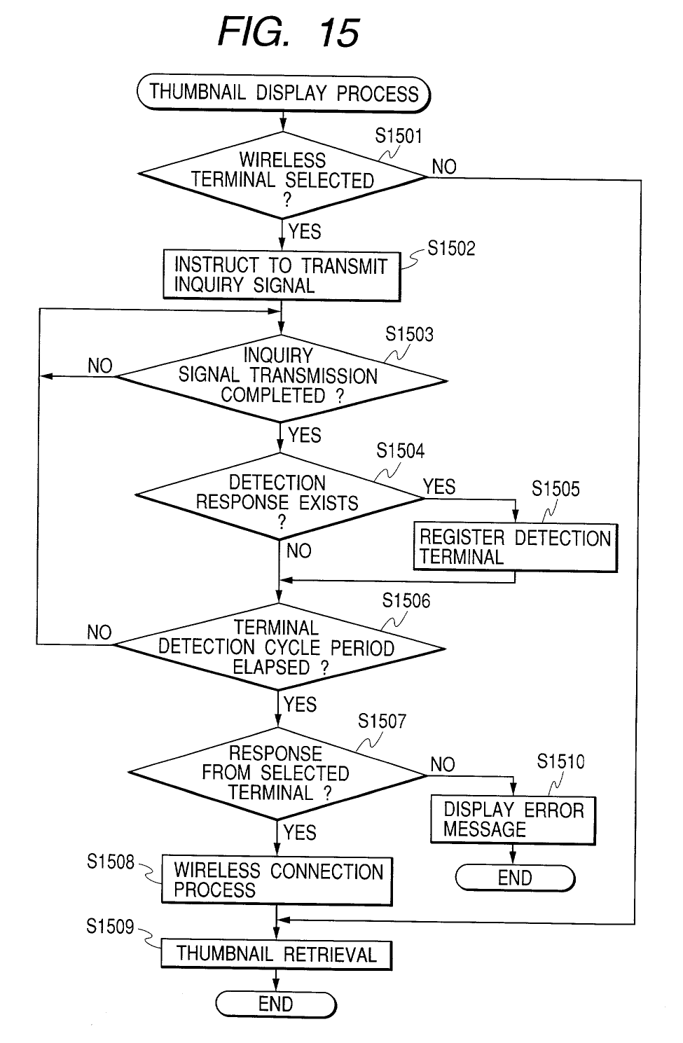

Next, the operation will be described with reference to FIG. 15.

FIG. 15 is a flowchart illustrating the operation of a program of making the server 1301 read a list of thumbnails of images stored in the image processing terminal such as a digital camera. The flowchart shown in FIG. 15 illustrates a portion of a program stored in the program storage unit 207. The control unit 204B is a computer which operates to execute the processes illustrated in FIG. 15 by reading the program from the program storage unit 207. The program storage unit 207 is a storage medium storing the program which the control unit 204B can read. This program may be stored in an external storage medium such as a floppy disk and a CD-ROM and the control unit 204B reads the program via an unrepresented floppy disk drive or CD-ROM drive. In this case, the program storage unit 207 corresponds to the storage medium storing the program which the control unit 204B can read. The program may be supplied externally to the control unit 204B via the reception unit 203. The operation of the server 1301 to be executed under the control of the control unit 204B will be described.

Referring to FIG. 15, in order to display thumbnails stored in a desired image processing terminal, a user of the server 1301 selects the desired image processing terminal from the input unit 250. In selecting the image processing apparatus, one of terminals in the list displayed at Step S5055 in FIG. 5 is selected by double-clicking it with a mouse of the input unit 250. If the selected terminal is an image processing terminal such as a digital camera, a thumbnail read program starts.

In response to the thumbnail request, the server 1301 judges whether the image processing terminal selected at Step S1501 is an image processing terminal having the wireless communication function. If it is judged that the selected image processing terminal is an image processing terminal having the wireless communication function, the flow advances to Step S1502, whereas if not, the flow jumps to Step S1509.

If the image processing terminal selected at Step S1501 has the wireless communication function, then at Step S1502 the control unit 204B of the server 1301 instructs the transmission unit 202 to transmit inquiry signals for the printer detection. Upon reception of this instruction, the transmission unit 202 transmits inquiry signals. Similar to the first and second embodiments, the inquiry signals are transmitted at the frequencies fk to fk+31.

After the transmission of the inquiry signals at the frequencies fk to fk+31 is completed (S1503), the control unit 204B of the server 1301 judges whether there is a response from an image processing terminal to the transmitted inquiry signal (S1504). If it is judged that there is a response from an image processing terminal to the inquiry signal, then at Step S1505 the address and the like of the image processing terminal which transmitted the response to the inquiry signal is registered in the terminal information storage unit 208A. The flow thereafter advances to Step S1506. On the other hand, if there is no response from an terminal to the transmitted inquiry signal, the flow advances to Step S1506.

At Step S1506, the server 1301 judges whether the inquiry signals were transmitted during a predetermined period or a predetermined number of times. If it is judged that the inquiry signals are still not transmitted during the predetermined period or the predetermined number of times, the flow returns to Step S1503 to execute Steps S1503 to S1506.

If it is judged that the inquiry signals were transmitted during the predetermined period or the predetermined number of times, at Step S1507 it is judged whether there is a response from the image processing terminal selected during the terminal detection operation. Namely, the information of the image processing terminal registered in the terminal information storage unit 208A at Step S1505 of the terminal detection operation is compared with the information of the selected image processing terminal to judge whether the selected image processing terminal is included in detected image processing terminals.

If it is judged that there is no response from the selected image processing terminal, the flow advances to Step S1510 whereat an error message is displayed on the display screen of the display unit 209 of the server 1301 to terminate the process. If there is a response from the selected image processing terminal, at Step S1508 the wireless connection process, i.e., the connection establishment process, is performed to advance to Step S1509.

At Step S1509 thumbnails are read from the selected image processing terminal and displayed on the display unit 209 of the server 1301 to thereafter terminate the process.

In this embodiment, if the selected image processing terminal is not detected, an error message is displayed at Step S1510 to terminate the process. However, if a new image processing terminal is selected from the list of detected image processing terminals displayed on the display screen of the server 1301, thumbnails may be read from the newly selected image processing terminal.

As described above, according to the third embodiment, as a user selects an image processing terminal by using the input unit, in response to an inquiry signal transmission request from the control unit 204B, the transmission unit 202 transmits inquiry signals for terminal detection. In accordance with the response signal to the transmitted inquiry signal, it is judged whether the selected image processing terminal is included in detected terminals.

Since the inquiry signals are transmitted to detect image processing terminals only when a user selects an image processing terminal for data communication, the transmission band of data communication can be utilized efficiently and the selected image processing terminal can be detected simply by selecting the image processing terminal for data communication on the side of a user.

In the above-described first to third embodiments, a data communication system having a server, computer terminals, printers or the like is used. The invention is not limited only thereto, but is applicable to other data communication system having portable information processing terminals such as cellar phones and personal digital assistants (PDA).

In the first to third embodiments, although the server 101, 601, 801, 1301 transmits inquiry signals, the inquiry signals may be transmitted from other terminals having the wireless communication function.

The scope of the invention contains also the case wherein software program codes realizing the function of each embodiment described above are supplied to a computer (CPU or MPU) of an apparatus or a system connected to various devices realizing the embodiment function, and the computer of the apparatus or system operates the devices in accordance with the stored programs.

In this case, the software program codes themselves realize the embodiment function. Therefore, the program codes themselves and means for supplying the program codes, e.g., a storage medium storing the program codes, constitute the present invention. The storage medium for storing such program codes may be a floppy disk, a hard disk, an optical disk, a magneto optical disk, a CD-ROM, a magnetic tape, a nonvolatile memory card, a ROM or the like.

It is obvious that the program codes are included in the embodiment of the invention, wherein not only the computer executes the supplied program codes to realize the embodiment function but also the program codes in cooperation with an OS (operating system) running on the computer or with another application or the like realize the embodiment function.

It is obvious that the scope of the invention also contains the case wherein the function of each embodiment can be realized by writing the program codes into a memory of a function expansion board inserted into a computer or of a function expansion unit connected to the computer, and thereafter by executing a portion or the whole of actual processes by a CPU of the function expansion board or function expansion unit.

As above, the invention is not limited to the structures of embodiments, but various modification are possible without departing from the scope of claims.

What is claimed is:

1. A method of detecting a communication apparatus, comprising: a selection step of selecting communication software for data communication; and a transmission step of transmitting an inquiry signal in response to a selection of a communication software.

2. A method according to claim 1, wherein said selection step judges whether selected software is the communication software.

3. A method according to claim 1, wherein said selection step includes a display step of displaying a window of selected software in a selected state.

4. A method according to claim 1, wherein said transmission step transmits the inquiry signal via a wireless channel.

5. A method according to claim 1, wherein said transmission step transmits the inquiry signal by using frequency hopping communication.

6. A method of detecting a communication partner comprising a transmission step of transmitting an inquiry signal for detecting a communication partner in accordance with a s election of the communication partner.

7. A method according to claim 6, wherein said transmission step includes a reception step of receiving data from the detected communication partner.

8. A method according to claim 6, wherein said transmission step transmits the inquiry signal via a wireless channel.

9. A method according to claim 6, wherein said transmission step transmits the inquiry signal by using frequency hopping communication.

10. A communication apparatus comprising:
detecting means for detecting a selection of communication software for data communication; and transmitting means for transmitting an inquiry signal for detecting a communication apparatus in response to a selection of the communication software.

11. A communication apparatus according to claim 10, wherein said detecting means judges whether selected software is the communication software.

12. A communication apparatus according to claim 10, wherein said detecting means includes displaying means for displaying a window of selected software in a selected state.

13. A communication apparatus comprising:
selecting means for selecting a communication partner;
and transmitting means for transmitting an inquiry signal to detect a communication partner in response to a selection of the communication partner.

14. A communication apparatus according to claim 13, wherein said transmitting means includes receiving means for receiving data from the detected communication partner.

15. A method of detecting a communication apparatus comprising a transmission step of transmitting an inquiry signal to detect a communication apparatus in response to an output request for data.

16. A method according to claim 15, wherein said transmission step includes an output step of outputting data to a predetermined communication apparatus in response to a detection of the predetermined communication apparatus.

17. A method according to claim 15, wherein the data output request is a print request.

18. A method according to claim 15, further comprising a display step of displaying a print instruction window in response to the data output request.

19. A method of detecting a communication apparatus comprising a transmission step of transmitting an inquiry signal to detect a communication apparatus in response to a data input request.

20. A method according to claim 19, wherein when a predetermined communication apparatus is detected, data is input from the detected communication apparatus.

21. A method according to claim 19, wherein the data input request is an input request for an image stored in a communication apparatus.

22. A communication apparatus comprising: input means for inputting a data output request; and transmitting means for transmitting an inquiry signal to detect a communication apparatus in response to the data output request.

23. A communication apparatus according to claim 22, further comprising display means for displaying a print instruction window in response to the data output request.

24. A communication apparatus comprising: input means for inputting a data input request; and transmitting means for transmitting an inquiry signal to detect a communication apparatus in response to the data input request.

25. A communication apparatus according to claim 24, wherein said transmitting means includes input means for inputting data from a predetermined communication apparatus in response to a detection of the predetermined communication apparatus.

26. A method of detecting a communication apparatus wherein in response to a start of a program, a window corresponding to the program is displayed, and when the window corresponding to the communication program is selected, an inquiry signal for detecting a communication apparatus is transmitted.

27. A method according to claim 26, wherein in response to the start of the program, an inquiry signal for detecting a communication apparatus is transmitted.

28. A method of detecting a communication apparatus wherein in response to an operation of enabling to select a printer displayed in a print instruction window, an inquiry signal for detecting a communication apparatus is transmitted.

29. A communication apparatus comprising: display means for displaying a window corresponding to a program in response to a start of the program; and transmitting means for transmitting an inquiry signal to detect a communication apparatus in response to a selection of the window corresponding to the communication program.

30. A communication apparatus according to claim 29, wherein said transmitting means transmits the inquiry signal to detect a communication apparatus in response to the start of the program.

31. A communication program for data communications or a storage medium storing the communication program, the communication program comprising: a selection step of selecting the communication program; and a transmission step of transmitting an inquiry signal to detect a communication apparatus.

32. A communication program or a storage medium according to claim 31, wherein said selection step includes a display step of displaying a window of selected software in a selected state.

33. A transmission control program or a storage medium storing the transmission control program, wherein the transmission control program comprises a transmission step of transmitting an inquiry signal to detect a communication partner in response to a selection of the communication partner.

34. A transmission control program or a storage medium according to claim 33, said transmitting step includes a receiving step of receiving data from a communication partner when the communication partner is detected.

35. A transmission control program or a storage medium storing the transmission control program, wherein the transmission control program comprises a transmission step of transmitting an inquiry signal to detect a communication apparatus in response to a data output request.

36. A transmission control program or a storage medium according to claim 35, wherein said transmission step includes an output step of outputting data to a predetermined communication apparatus when the predetermined communication apparatus is detected.

37. A transmission control program or a storage medium according to claim 35, wherein the data output request is a print request.

38. A transmission control program or a storage medium according to claim 35, wherein the transmission control program further comprises a display step of displaying a print instruction window in response to the data output request.

39. A transmission control program or a storage medium storing the transmission control program, wherein the transmission control program comprises a transmission step of transmitting an inquiry signal to detect a communication apparatus in response to a data input request.

40. A transmission control program or a storage medium according to claim 39, wherein when a predetermined communication apparatus is detected, data is input from the detected communication apparatus.

41. A transmission control program or a storage medium according to claim 39, wherein the data input request is an input request for an image stored in a communication apparatus.

42. A communication program or a storage medium storing the communication program, wherein when the communication program starts, the communication program operates to display a window corresponding to the communication program and transmit an inquiry signal to detect a communication apparatus in response to a selection of the window corresponding to the communication program.

43. A communication program or a storage medium according to claim 42, wherein in response to the start of the communication program, the inquiry signal is transmitted to detect a communication apparatus.

44. A transmission control program or a storage medium storing the transmission control program, wherein the transmission control program comprises a step of transmitting an inquiry signal to detect a communication apparatus in response to an operation of enabling to select a printer displayed in a print instruction window.
